(19) United States
(12) Patent Application Publication
(10) Pub. No.: US 2025/0176043 A1
(43) Pub. Date: May 29, 2025

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/715,589

(22) PCT Filed: Dec. 3, 2021
(86) PCT No.: PCT/CN2021/135347

§ 371 Date: Jun. 3, 2024

(51) Int. Cl. H04W 76/14; H04W 8/00; H04W 76/20; H04W 92/18

(52) U.S. Cl. CPC H04W 76/14; H04W 8/005; H04W 76/20; H04W 92/18

(57) ABSTRACT

Embodiments of the present disclosure relate to methods, devices and computer readable media for communication. A first device receives first information of a second device in a set of second devices, the first information comprising at least one of: a radio resource control state, serving node identity information, or a sidelink connection with the first device. A target device is determined from the set of second devices based on the first information. The first device performs communication via the target device. In this way, signaling overhead in sidelink relay may be saved, and latency in sidelink relay may be reduced.

### TECHNICAL FIELD

Embodiments of the present disclosure generally relate to the field of telecommunication, and in particular, to methods, devices and computer storage media of communication for sidelink relay.

### BACKGROUND

In context of new radio (NR) sidelink relay, a user equipment (UE) that is communicated with a gNB via another UE in coverage (IC) of the gNB is called as a remote UE, and the other UE is called as a relay UE. The remote UE may be out of coverage (OoC) of the gNB, and also may be in coverage of the gNB. A connection is established between the remote UE and the relay UE via a sidelink.

In study of sidelink relay, there is a need to specify mechanisms for service continuity which include direct to indirect path switch. A direct path means there is no relay UE between a remote UE and a gNB and an indirect path means there is a relay UE between a remote UE and a gNB. For the direct to indirect path switch, implementation for selection of a relay UE is incomplete and to be further developed.

### SUMMARY

In general, embodiments of the present disclosure provide methods, devices and computer storage media of communication for sidelink relay.

In a first aspect, there is provided a method of communication. The method comprises: receiving, at a first device, first information of a second device in a set of second devices, the first information comprising at least one of: a radio resource control state, serving node identity information, or a sidelink connection with the first device; and performing a communication with a third device via a target device, the target device being determined from the set of second devices based on the first information.

In a second aspect, there is provided a method of communication. The method comprises: transmitting, at a second device and to a first device, information of the second device for determination of a target device, the first device communicating with a third device via the target device, the information comprising at least one of: a radio resource control state, serving node identity information, or a sidelink connection with the first device.

In a third aspect, there is provided a method of communication. The method comprises: determining, at a fourth device, a target device from a set of second devices based on first information of a second device in the set of second devices, the first information comprising at least one of: a radio resource control state, serving node identity information, or a sidelink connection with a first device; and configuring the first device to be communicated with a third device via the target device.

In a fourth aspect, there is provided a method of communication. The method comprises: receiving, at a third device and from a second device in an inactive state, a request for resuming a connection between the second device and the third device, wherein a communication between a first device and the third device is to be performed via the second device; and in accordance with a determination that the third device is not the last serving device of the second device, transmitting, to a fifth device as the last serving device of the second device, a message for requesting a context of the second device, the message comprising an indication that the second device serves as a relay.

In a fifth aspect, there is provided a method of communication. The method comprises: receiving, at a third device and from a second device in an inactive state, a request for resuming a connection between the second device and the third device, wherein a communication between a first device and the third device is to be performed via the second device; and transmitting, to the second device, a message for resuming the connection, the message comprising a configuration for relay.

In a sixth aspect, there is provided a device of communication. The device comprises a processor configured to perform the method according to the first or second aspect of the present disclosure.

In a seventh aspect, there is provided a device of communication. The device comprises a processor configured to perform the method according to the third, fourth or fifth aspect of the present disclosure.

In an eighth aspect, there is provided a computer readable medium having instructions stored thereon. The instructions, when executed on at least one processor, cause the at least one processor to perform the method according to the first or second aspect of the present disclosure.

In a ninth aspect, there is provided a computer readable medium having instructions stored thereon. The instructions, when executed on at least one processor, cause the at least one processor to perform the method according to the third, fourth or fifth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure may be implemented;

FIG. 2 illustrates a schematic diagram illustrating a process for communication for sidelink relay according to embodiments of the present disclosure:

FIG. 3 illustrates a schematic diagram illustrating another process for communication for sidelink relay according to embodiments of the present disclosure:

FIG. 4 illustrates a schematic diagram illustrating still another process for communication for sidelink relay according to embodiments of the present disclosure:

FIG. 5 illustrates a schematic diagram illustrating yet another process for communication for sidelink relay according to embodiments of the present disclosure:

FIG. 6 illustrates a flowchart for an example method of communication implemented at a first device in accordance with some embodiments of the present disclosure:

FIG. 7 illustrates a flowchart for an example method of communication implemented at a second device in accordance with some embodiments of the present disclosure:

FIG. 8 illustrates a flowchart for an example method of communication implemented at a fourth device in accordance with some embodiments of the present disclosure;

FIG. 9 illustrates a flowchart for an example method of communication implemented at a third device in accordance with some embodiments of the present disclosure:

FIG. 10 illustrates a flowchart for another example method of communication implemented at a third device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “remote UE” refers to a terminal device that is communicated with a network device via another terminal device in coverage of the network device. The term “relay UE” refers to a terminal device that is in coverage of a network device and via which remote UE is communication with the network device. The relay UE is connected with the remote UE via a sidelink interface such as a PC5 interface or the like. The term “remote UE” can be used interchangeably with a remote terminal device or a remote device. The term “relay UE” can be used interchangeably with a relay terminal device or a relay device. The term “sidelink connection” can be used interchangeably with a PC5 link or a PC5 connection.

In the context of the present application, the term “identity” can be used interchangeably with the term “identifier”. The term “a set of second devices” means one or more second devices.

For service continuity, in some scenarios, remote UE may be switched from communicating with the gNB directly to communicating with gNB indirectly via relay UE (also referred to as a target device herein). For these scenarios, the target device needs to be determined.

It has been agreed that two options may be used for determination of a target device of a direct to indirect path switch. One option is that the target device should be in a connected state. Another option is that the target device may be in an idle or inactive state, and in this case, the remote UE establishes a PC5 link with the target device upon reception of a path switch command and transmits a handover complete message via the target device which will trigger the relay UE to enter a connected state. For these options, how to select the target device is highly concerned. For example, how to identify a target device in a connected state and how to handle a target device in an idle or inactive state.

Embodiments of the present disclosure provide a solution for sidelink relay. In one aspect, a target device is determined from a set of relay UEs based on information comprising at least one of a radio resource control (RRC) state, serving node identity (ID) information, or a sidelink connection with a remote UE. Then the remote UE performs communication via the target device. In this way, a target device in a connected state may be selected and communication latency for path switch may be reduced.

In another aspect, if a target device is in an inactive state, when a network device serving the target device requests a context of the target device from the last serving device of the target device, the network device transmits an indication that the target device serves as a relay. In this way, the context may be obtained surely and communication performance in path switch may be improved.

In still another aspect, if a target device is in an inactive state, when a network device serving the target device receives a resume request from the target device, the network device transmits a resume message with relay related configuration. In this way, communication latency for path switch may be reduced.

Principles and implementations of the present disclosure will be described in detail below with reference to the figures.

### Example of Communication Network

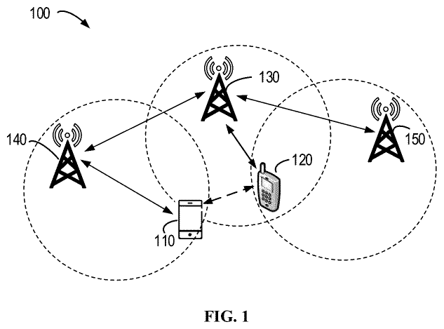

FIG. 1 illustrates a schematic diagram of an example communication network 100 in which some embodiments of the present disclosure can be implemented. As shown in FIG. 1, the communication network 100 may include a first device 110, a second device 120, a third device 130 and a fourth device 140. The third device 130 provides a cell to serve one or more devices. The fourth device 140 also provides a cell to serve one or more devices. In the example of FIG. 1, the second device 120 is located within the cell of the third device 130, and the second device 120 may directly communicate with the third device 130. The first device 110 is located within the cell of the fourth device 140, and the first device 110 may directly communicate with the fourth device 140.

In the example of FIG. 1, the communication network 100 may also include a fifth device 150. The fifth device 150 is the last serving device of the second device 120. The third device 130, the fourth device 140 and the fifth device 150 may communicate with each other, e.g., via X2 or Xn or F1 or S1 interface.

In some embodiments, the second device 120 and the third device 130 may communicate with each other via a channel such as a wireless communication channel. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

In some embodiments, the first device 110 and the second device 120 may communicate with each other via a sidelink channel such as a physical sidelink shared channel (PSSCH), a physical sidelink control channel (PSCCH), a physical sidelink feedback channel (PSFCH), a physical sidelink broadcast channel (PSBCH) or the like. For example, a PC5 link, a PC5 unicast link or PC5 RRC connection may be established between the first device 110 and the second device 120.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices in FIG. 1 is given for the purpose of illustration without suggesting any limitations to the present disclosure. The communication network 100 may include any suitable number of first devices, second devices, third devices, fourth devices and fifth devices adapted for implementing implementations of the present disclosure.

For illustration, the first device 110 and the second device 120 are shown as terminal devices and the third device 130, the fourth device 140 and the fifth device 150 are shown as network devices. Merely for illustration purpose and without suggesting any limitations as to the scope of the present disclosure, some embodiments will be described in the context where the first device 110 and the second device 120 are shown as terminal devices and the third device 130, the fourth device 140 and the fifth device 150 are shown as network devices. The first device 110 corresponds to remote UE, and the second device 120 corresponds to relay UE. It is to be understood that the communication network 100 may comprise multiple devices that can serve as relay UEs.

It is to be understood that in some other scenarios, the first device 110 may also serve as relay UE, and/or the second device 120 may also serve as remote UE. The present disclosure does not limit this aspect.

In addition, it is to be understood that, in other embodiments, the first device 110 and/or the second device 120 may be a network device and the third device 130, the fourth device 140 and/or the fifth device 150 may be a terminal device. In other words, the principles and spirits of the present disclosure can be applied to both uplink and downlink transmissions. Further, in some embodiments, all of the first device 110, the second device 120, the third device 130 the fourth device 140 and the fifth device 150 may be terminal devices, and in some embodiments, all of the first device 110, the second device 120, the third device 130 the fourth device 140 and the fifth device 150 may be network devices. The present application does not limit this aspect.

In the example of FIG. 1, the first device 110 is located outside the cell of the third device 130. The first device 110 is connected with the second device 120 via a sidelink interface (for example, PC5 interface or the like). In some scenarios, as the first device 110 moves, the first device 110 may switch from communicating with the fourth device 140 directly to communicating with the third device 130 via the second device 120 for service continuity. In this case, the first device 110 corresponds to a remote UE, and the second device 120 corresponds to a relay UE.

For illustration, in the example of FIG. 1, the third device 130, the fourth device 140 and the fifth device 150 are shown as different devices. However, it is to be understood that some or all of the third device 130, the fourth device 140 and the fifth device 150 may be the same device in some embodiments.

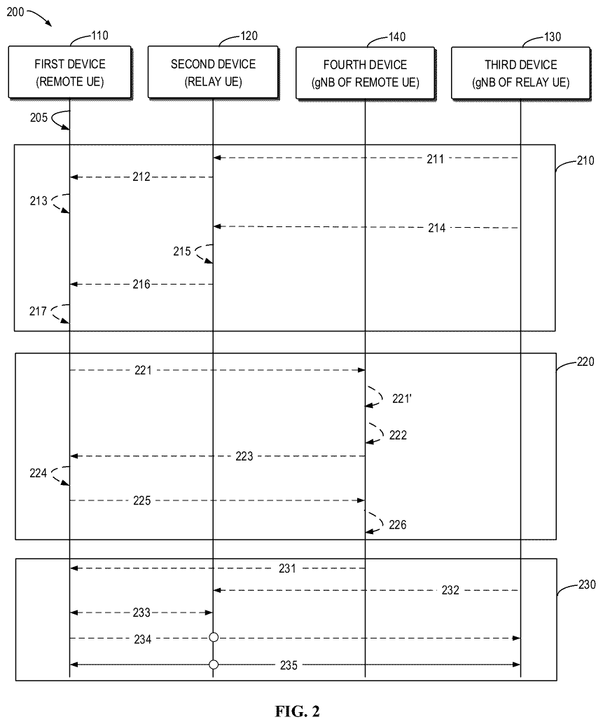

Embodiments of the present disclosure provide solutions for sidelink relay. The detailed description will be made below with reference to FIGS. 2 to 6.

Example Implementation of Sidelink Relay with Relay UE in Connected State

In some embodiments, a target device may be determined from a set of relay UEs based on information from remote UE. In some embodiments, a target device may be determined from a set of relay UEs based on information from one or more neighbor network devices of a network device serving remote UE. For illustration, some example embodiments will be detailed in connection with Embodiments 1 and 2.

### Embodiment 1

In this embodiment, a target device may be determined from a set of relay UEs based on information from remote UE. This will be described with reference to FIG. 2.

FIG. 2 illustrates a schematic diagram illustrating a process 200 for communication for sidelink relay according to embodiments of the present disclosure. For the purpose of discussion, the process 200 will be described with reference to FIG. 1. The process 200 may involve the first device 110, the second device 120, the third device 130 and the fourth device 140 as illustrated in FIG. 1. The steps and the order of the steps in FIG. 2 are merely for illustration, and not for limitation. For example, the order of the steps may be changed. Some of the steps may be omitted or any other suitable additional steps may be added. Assuming that the first device 110 is to perform a direct to indirect path switch. For convenience, assuming that the first device 110 is a remote UE, the second device 120 is a relay UE, the third device 130 is gNB of the relay UE, and the fourth device 140 is gNB of the remote UE.

As shown in FIG. 2, the first device 110 determines 205 a set of second devices 120 by performing measurement based on a discovery message. For example, the first device 110 may receive a discovery message from a plurality of second devices 120 that can be used as a relay UE(s), and select, from the plurality of second devices 120, the set of second devices 120 for which receiving power of the discovery message or the unicast transmission fulfills a predetermined criterion. Of course, the set of second devices 120 may be determined in any other suitable ways, and the present disclosure does not limit this aspect.

Then the first device 110 determines 210 information (for convenience, also referred to as first information herein) of each device in the set of second devices 120, the information comprising at least one of a RRC state, serving node ID information or a sidelink connection with the first device 110.

In some embodiments, the third device 130 may transmit 211, to the second device 120, an indication to cause the second device 120 to transmit the first information to the first device 110. In some embodiments, the third device 130 may transmit the indication to cause the second device 120 to transmit information comprising at least one of a RRC state or serving node ID information to the first device 110. In some embodiments, the third device 130 may transmit the indication by a system information block (SIB), a RRC message, a layer 2 (L2) control information or a layer 1 (L1) signaling before sending a discovery message.

In response to receiving the indication, the second device 120 may transmit 212, the first information to the first device 110. In some alternative embodiments, the second device 120 may transmit, without the indication from the third device 130, the first information to the first device 110.

In some embodiments, the second device 120 may transmit the first information in the discovery message. In some embodiments, the second device 120 may transmit the first information in sidelink control information (SCI) (e.g., SCI for scheduling the transmission of the discovery message). In some embodiments, the second device 120 may transmit the first information in a physical sidelink broadcast channel (PSBCH). In some embodiments, the second device 120 may transmit the first information in a PC5-RRC signaling for configuring the sidelink connection or a PC5-S signaling (e.g., signaling for establishing the sidelink connection). That is, the second device 120 may transmit the first information to the first device 110 via a message specific to the first device 110.

In some embodiments, the first information may be indicated by a single bit. For example, “1” is used for indicating a connected state (RRC_CONNECTED), and “0” is used for indicating other states. In some embodiments, the first information may be indicated by a bit sequence, e.g., two bits. For example, “00” is used for indicating an idle state (RRC_IDLE), “01” is used for indicating an inactive state (RRC_INACTIVE), “10” is used for indicating a connected state (RRC_CONNECTED). In some embodiments, the first information may be indicated by an enumerated variable. For example, the enumerated variable may be an idle state (RRC_IDLE), an inactive state (RRC_INACTIVE), and a connected state (RRC_CONNECTED). As another example, the enumerated variable may be a connected state (RRC_CONNECTED) and other states. In this way, the RRC state of a second device may be explicitly indicated by the first information.

In some embodiments, the first information may be indicated by a radio access network (RAN) ID of the second device 120. For example, inactive-radio network temporary identity (I-RNTI) stands for RRC_INACTIVE, cell-radio network temporary identity (C-RNTI) stands for RRC_CONNECTED, and default value/5G S-temporary mobile subscription identifier/5G temporary mobile subscription identifier (5G-S-TMSI/5G-TMSI) stands for RRC_IDLE. As another example, I-RNTI stands for RRC_INACTIVE, default value stands for RRC_CONNECTED, and 5G-S-TMSI/5G-TMSI stands for RRC_IDLE. In this way, the RRC state of a second device may be indicated by the first information in an implicit way.

In some embodiments where the first information comprises serving node ID information, the first information may comprise a cell ID and a UE ID of the second device 120. For example, the cell ID may be a NR cell identifier (NCI). For example, the NCI may comprise 36 bits. For example, the cell ID may be a NR cell global identifier (NCGI). For example, the NCI may comprise 36 bits. In some alternative embodiments, the first information may comprise the cell ID, the UE ID and a gNB ID of the second device 120. For example, the gNB ID may comprise 22 bits or 32 bits. In some alternative embodiments, the first information may comprise the cell ID, the UE ID and an indicator of a length of a gNB ID of the second device 120. It is to be understood that the first information may also adopt any other suitable forms for indicating the serving node ID information.

In some embodiments, the first device 110 may determine 213 whether a sidelink connection is established between the second device 120 and the first device 110. In some alternative embodiments, the first device 110 may receive, from the second device 120, the information of the sidelink connection.

In some alternative embodiments, if the first device 110 receives a discovery message from the second device 120, the first device 110 may determine the RRC state of the second device 120 as a connected state. In these embodiments, the third device 130 may transmit 214, to the second device 120, an indication indicating that a discovery message is transmitted if the second device 120 is in the connected state. In response to receiving the indication, the second device 120 may determine 215 whether the second device 120 is in the connected state. If the second device 120 is in the connected state, the second device 120 may transmit 216 a discovery message to the first device 110. If the second device 120 is not in the connected state, the second device 120 may not transmit a discovery message to the first device 110.

Alternatively, without the indication from the third device 130, the second device 120 may determine whether the second device 120 is in the connected state and transmit a discovery message to the first device 110 if the second device 120 is in the connected state.

In response to receiving the discovery message from the second device 120, the first device 110 may determine 217 the RRC state of the second device 120 as a connected state. In this way; signaling overhead may be further reduced.

Continue to with reference to FIG. 2, the fourth device 140 determines 220 a target device from the set of second devices 120. In some embodiments, the first device 110 may transmit 221 the first information to the fourth device 140 for determination of the target device. It is to be understood that the first information indicates the set of second devices 120 and the corresponding first information comprising RRC state, serving node ID information and/or PC5 state (e.g. sidelink connection with the first device 110). For example, the first device 110 may transmit, to the fourth device 140, an ID of a second device in the set of second devices and the first information associated with the ID. For example, the first device 110 may transmit, to the fourth device 140, an ID of a second device in the set of second devices and serving node ID and/or PC5 state associated with the ID. In some embodiments, the first information may be transmitted by a RRC message. For example, the first information may be transmitted by a MeasurementReport message. As another example, the first information may be transmitted by Sidelink UE Information (SUI) message or UE Assistance Information (UAI) message. In some embodiments, the first information may be transmitted by PC5-RRC signaling. In some embodiments, the first information may be transmitted by PC5-S signaling.

In some embodiments, upon reception of the first information, the fourth device 140 may store 221′ the first information. In some embodiments, the first information may be stored in a variable. In some embodiments, the first information may be stored in a neighbor cell relation table (NCRT). In some embodiments, the first information may be stored in UE context. In some embodiments, serving node ID information may be used as an index. For example, for each serving node ID information, a list of (UE ID, RRC state, PC5 state) may be stored. In some embodiments, a UE ID may be used as an index. In another example, for each UE ID, a list of (RRC state, PC5 state, serving node ID information) may be stored.

In these embodiments, the fourth device 140 may determine 222 the target device from the set of second devices 120 based on the first information of the set of second devices 120. For example, in some embodiments, the fourth device 140 may determine the target device so that the RRC state of the target device is a connected state. In some embodiments, the fourth device 140 may determine the target device so that the serving node ID information of the target device indicates the fourth device 140 (i.e., intra-gNB). In some embodiments, the fourth device 140 may determine the target device so that the target device is in the sidelink connection with the first device 110. For example, in some embodiments, the fourth device 140 may determine the target device so that the RRC state of the target device is an inactive state. In some embodiments, the fourth device 140 may determine the target device so that the serving node ID information of the target device indicates the third device 130 (i.e., inter-gNB). Of course, the target device may also fulfill any other suitable conditions or combination of conditions.

As another example, the fourth device 140 may determine a set of candidates from the set of second devices 120 such that at least one of the following: a RRC state of a candidate in the set of candidates is a connected state: serving node ID information of a candidate in the set of candidates indicates the fourth device 140; or a candidate in the set of candidates is in the sidelink connection with the first device 110. Then the fourth device 140 may determine the target device from the set of candidates based on any suitable criterion. For example, the fourth device 140 may determine, as the target device, a candidate in the set of candidates having the strongest receiving power. As another example, the fourth device 140 may determine, as the target device, a candidate in the set of candidates having the lowest load (e.g. the lowest traffic load, or the minimum number of PC5 connections).

In some alternative embodiments, the set of candidates may be determined by the first device 110. In these embodiments, the fourth device 140 may transmit 223, to the first device 110, a configuration indicating transmission of the set of candidates for the target device. For example, the configuration may indicate that a RRC state of each candidate in the set of candidates is a connected state. In another example, the configuration may indicate that serving node ID information of each candidate in the set of candidates indicates the fourth device 140 (i.e., intra-gNB). In still another example, the configuration may indicate that each candidate in the set of candidates is in a sidelink connection with the first device 110. It is to be understood that the configuration may indicate any combination of the above conditions or any other suitable conditions.

In some embodiments, the configuration may comprise a single bit. For example, “1” may be used for indicating a connected state (RRC_CONNECTED), and “0” may be used for indicating other states. As anther example, “1” may be used for indicating intra-gNB only, and “0” is used for indicating both intra-gNB and inter-gNB. In some embodiments, the configuration may comprise an enumerated variable. For example, the enumerated variable may be a connected state (RRC_CONNECTED) and other states. As anther example, the enumerated variable may comprise intra-gNB only, and both intra-gNB and inter-gNB. In some embodiments, the configuration may comprise a Boolean variable. For example, the Boolean variable may indicate true for a connected state (RRC_CONNECTED) and false for other states. In another example, the Boolean variable may indicate true for intra-gNB only, and false for both intra-gNB and inter-gNB. In still another example, presence of the configuration may stand for intra-gNB only, and absence of the configuration may stand for both intra-gNB and inter-gNB. It is to be understood that the configuration may also adopt any other suitable forms.

Then the first device 110 may determine 224 the set of candidates based on the configuration. For example, the first device 110 may determine the set of candidates such that at least one of the following: a RRC state of a candidate in the set of candidates is a connected state: serving node ID information of a candidate in the set of candidates indicates the fourth device 140; or a candidate in the set of candidates is in the sidelink connection with the first device 110.

The first device 110 may transmit 225 information (for convenience, also referred to as second information) indicating the set of candidates to the fourth device 140. In some embodiments, the second information may be transmitted by a RRC message. For example, the second information may be transmitted by a MeasurementReport message. In another example, the second information may be transmitted by a SUI message or a UAI message. In some embodiments, the second information may be transmitted by PC5-RRC signaling. In some embodiments, the second information may be transmitted by PC5-S signaling.

In this case, the fourth device 140 may determine 226 the target device from the set of candidates indicated by the second information based on any suitable criterion. For example, the fourth device 140 may determine, as the target device, a candidate in the set of candidates having the strongest receiving power. As another example, the fourth device 140 may determine, as the target device, a candidate in the set of candidates having the lowest load (e.g. the lowest traffic load, or the minimum number of PC5 connections).

In some alternative embodiments, the first device 110 may determine the set of candidates and transmit the second information indicating the set of candidates to the fourth device 140 without the configuration from the fourth device 140.

In some alternative embodiments, the first device 110 may transmit both the first and second information to the fourth device 140. For example, the first and second information may be transmitted in the same message such as MeasurementReport message. For another example, the first and second information may be transmitted in separate messages. In these embodiments, the fourth device 140 may determine the target device based on the first and second information by any suitable criterion. The present disclosure does not limit this aspect. With the determination and transmission of the set of candidates by the first device 110, signaling overhead is saved as only information of a subset in the set of second devices needs to be transmitted. In case that the set of candidates are in sidelink connection with the first device 110, interruption caused by path switch may be shortened.

Upon determination of the target device, the first device 110 and the target device are configured 230 so that the first device 110 communicates with the third device 130 via the target device. As shown in FIG. 2, in some embodiments, the fourth device 140 may transmit 231 a RRC reconfiguration message comprising a relay related configuration to the first device 110 and the third device 130 may transmit 232 a RRC reconfiguration message comprising a relay related configuration to the second device 120 (i.e., the target device). If there is no sidelink connection between the first device 110 and the second device 120 (i.e., the target device), the first device 110 may establish 233 the sidelink transmission with the second device 120 (i.e., the target device). Then the first device 110 may transmit 234 a RRC reconfiguration complete message to the third device 130 via the second device 120 (i.e., the target device). In this way, the first device 110 may perform 235 uplink or downlink transmission with the third device 130 via the second device 120 (i.e., the target device). It is to be understood that the operation of the configuration 230 may be carried out in any suitable ways, and the present disclosure does not limit this aspect.

With the process of FIG. 2, signaling overhead in sidelink relay may be saved and latency in sidelink relay may be reduced.

### Embodiment 2

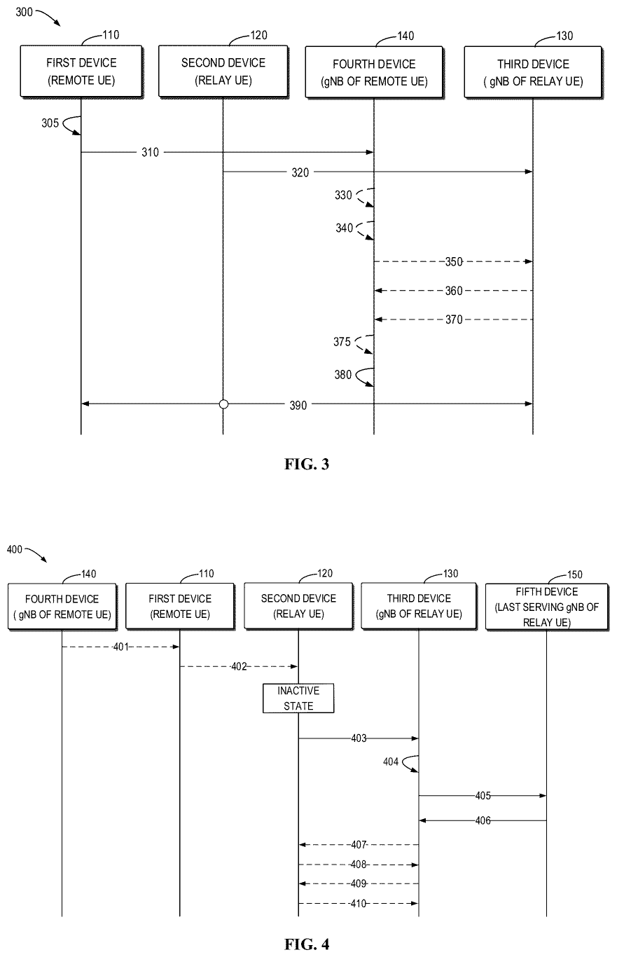

In this embodiment, a target device may be determined from a set of relay UEs based on information from one or more neighbor network devices of a network device serving remote UE. This will be described with reference to FIG. 3.

FIG. 3 illustrates a schematic diagram illustrating another process 300 for communication for sidelink relay according to embodiments of the present disclosure. For the purpose of discussion, the process 300 will be described with reference to FIG. 1. The process 300 may involve the first device 110, the second device 120, the third device 130 and the fourth device 140 as illustrated in FIG. 1. The steps and the order of the steps in FIG. 3 are merely for illustration, and not for limitation. For example, the order of the steps may be changed. Some of the steps may be omitted or any other suitable additional steps may be added. Assuming that the first device 110 is to perform a direct to indirect path switch. For convenience, assuming that the first device 110 is remote UE, the second device 120 is relay UE, the third device 130 is gNB of relay UE, and the fourth device 140 is gNB of remote UE.

As shown in FIG. 3, the first device 110 determines 305 a set of second devices 120 by performing measurement based on a discovery message. For example, the first device 110 may receive a discovery message or unicast transmission from a plurality of second devices 120 that can be used as relay UE, and select, from the plurality of second devices 120, the set of second devices 120 for which receiving power of the discovery message or unicast transmission (i.e. SL-RSRP or SD-RSRP) fulfills a predetermined criterion. Of course, the set of second devices 120 may be determined in any other suitable ways, and the present disclosure does not limit this aspect.

Then the first device 110 transmits 310, to the fourth device 140, a measurement report indicating the set of second devices 120. For example, the measurement report may comprise an ID of each device in the set of second devices 120 and serving node ID information associated with the device and/or receiving power (i.e. SL-RSRP or SD-RSRP). Based on the measurement report, the fourth device 140 may determine the set of second devices 120.

In some embodiments, a second device (for example, the second device 120) may report 320, to its serving device (for example, the third device 130), information comprising at least one of a RRC state, serving node ID information, PC5 state via SUI or UAI. For example, the second device 120 may report the information periodically. Of course, the second device 120 may report the information aperiodically. In another example, the fourth device 140 may obtain the first information of the set of second devices 120 from the fourth device 140 or its neighbor network device (for example, the third device 130).

In some embodiments, the fourth device 140 may receive, from the second device 120 or the first device 110, an identity (for convenience, also referred to as a first identity herein) of a sidelink connection associated with the second device 120. For example, the first identity may comprise at least one of a source L2 ID or a target L2 ID or L2 link ID indicating the second device 120. In these embodiments, the fourth device 140 may map 330 the first identity into an identity (for convenience, also referred to as a second identity herein) of the second device 120 in a RAN. For example, the first identity may comprise at least one of C-RNTI, I-RNTI, 5G-S-TMSI, 5G-S-TMSI, local or temp ID (i.e, allocated by the serving device of the second device 120). The second identity may comprise a Uu ID.

For example, a second device may report its source L2 ID of its PC5 connection to its serving device via UAI or SUI. The serving device (for example, the third device 130) may record the source L2 ID (e.g., in UE context) along with associated Uu ID (such as C-RNTI, I-RNTI, 5G-TMSI or 5G-S-TMSI) of the second device. As another example, a second device (i.e., relay UE) may provide its Uu ID to a first device (i.e., remote UE), for example, in a discovery message, SCI, PSBCH, PC5-S signaling or a PC5-RRC signaling. A first device (i.e., remote UE) may report a source L2 ID and/or target L2 ID of its PC5 connection to its serving device (for example, the fourth device 140) via UAI or SUI. The serving device may record the target L2 ID and/or source L2 ID (e.g., in UE context) along with associated Uu ID (such as C-RNTI, I-RNTI, 5G-TMSI or 5G-S-TMSI) of the second device. In this case, the fourth device 140 may perform the mapping from the first identity to the second identity by looking up the record.

Then the fourth device 140 may obtain the first information based on the second identity. In some embodiments, the fourth device 140 may locally obtain 340 the first information of a second device served by the fourth device 140. It is to be understood that the fourth device 140 may locally obtain the first information of one or more second devices served by the fourth device 140.

In some embodiments, the fourth device 140 may transmit 350, to the third device 130, a request for obtaining the first information of a second device served by the third device 130, and receive 360, from the third device 130, a response to the request comprising the first information. For example, the fourth device 140 may transmit the request for obtaining the first information in an existing message (i.e Xn message, F1 message, RRC message) such as a handover request message to the third device 130, and receive the response in an existing message such as a handover request acknowledgement message. In another example, the fourth device 140 may transmit the request for obtaining the first information in a newly defined or dedicated message (via Xn, or F1 or Uu interface), and receive the response in a newly defined or dedicated message. In some embodiments, the fourth device 140 may periodically transmit, to a neighbor network device, the request for obtaining the first information of a second device served by the neighbor network device. In some embodiments, the fourth device 140 may transmit, to a neighbor network device, the request for obtaining the first information of a second device served by the neighbor network device in response to receiving the measurement report indicating the set of second devices 120. In this way, the fourth device 140 may periodically obtain the first information of a second device served by a neighbor network device.

It is to be understood that the fourth device 140 may obtain, from the third device 130, the first information of one or more second devices served by the third device 130.

In some alternative embodiments, the third device 130 may announce 370, to the fourth device 140, the first information of a second device served by the third device 130. In some embodiments, the third device 130 may periodically announce the first information of a second device served by the third device 130. In this way, the fourth device 140 may periodically obtain the first information of a second device served by a neighbor network device.

It is to be understood that the third device 130 may announce, to the fourth device 140, the first information of one or more second devices served by the third device 130.

In some embodiments, upon reception of the first information, the fourth device 140 may store 375 the first information. In some embodiments, the first information may be stored in a variable. In some embodiments, the first information may be stored in a NCRT. In some embodiments, the first information may be stored in UE context. In some embodiments, a serving node ID may be used as an index. For example, for each serving node ID, a list of (UE ID, RRC state, PC5 state) may be stored. In some embodiments, a UE ID may be used as an index. In another example, for each UE ID, a list of (RRC state, PC5 state, serving node ID information) may be stored.

Upon determination of the first information, the fourth device 140 determines 380 a target device from the set of second devices based on the first information of the set of second devices. The operation of the determination 380 is similar with the operation of the determination 222 as described in FIG. 2, and thus is not repeated here for concise.

Upon determination of the target device, the first device 110 and the target device are configured 390 so that the first device 110 communicates with the third device 130 via the target device. The operation of the configuration 390 is similar with the operation of the configuration 230 as described in FIG. 2, and thus is not repeated here for concise.

With the process of FIG. 3, signaling overhead in Uu interface may be saved and UE complexity may be reduced.

Example Implementation of Sidelink Relay with Relay UE in Inactive State

In some scenarios, a target device may be in an inactive state. Some example embodiments for these scenarios will be detailed in connection with Embodiments 3 and 4.

### Embodiment 3

In this embodiment, if a serving device of a target device is not the last serving device of the target device, the serving device transmit, to the last serving device, an indication that the target device serves as a relay in a message for requesting a context of the target device. This facilitates the last serving device to surely transmit or transfer the context of the target device to the serving device, and thus latency in establishing sidelink relay may be reduced. This will be described in details with reference to FIG. 4.

FIG. 4 illustrates a schematic diagram illustrating still another process 400 for communication for sidelink relay according to embodiments of the present disclosure. For the purpose of discussion, the process 400 will be described with reference to FIG. 1. The process 400 may involve the first device 110, the second device 120, the third device 130, the fourth device 140 and the fifth device 150 as illustrated in FIG. 1. The steps and the order of the steps in FIG. 4 are merely for illustration, and not for limitation. For example, the order of the steps may be changed. Some of the steps may be omitted or any other suitable additional steps may be added. Assuming that the first device 110 is to perform a communication via a target device in an inactive state. For convenience, assuming that the first device 110 is remote UE, the second device 120 is the target device, the third device 130 is gNB of the target device, and the fourth device 140 is gNB of the remote UE.

As shown in FIG. 4, the fourth device 140 may transmit 401 a RRC reconfiguration message comprising a relay related configuration to the first device 110. In this case, the first device 110 may transmit 402 a RRC reconfiguration complete message (i.e. via PC5 signaling) to the second device 120.

Upon reception of the RRC reconfiguration complete message, the second device 120 transmits 403, to the third device 130, a request for resuming a connection between the second device 120 and the third device 130. In response to receiving the request, the third device 130 determines 404 whether the third device 130 is the last serving device of the second device 120.

If the third device 130 is not the last serving device of the second device 120, the third device 130 transmits 405, to the fifth device 150, a message for requesting a context of the second device 120. The message comprises an indication that the second device 120 serves as a relay or the context of the target device should be surely transmitted or transferred. It is to be understood that the indication may adopt any suitable forms and the present disclosure does not make limitation for this. Then the fifth device 150 transmits 406 the context of the second device 120 to the third device 130.

In some embodiments, if a message for requesting the context of the second device 120 does not comprise the indication, the fifth device 150 may not transmit the context of the second device 120 to the third device 130.

Based on the context of the second device 120, the third device 130 may resume the connection with the second device 120 and configure the second device 120 as a relay. For example, the third device 130 may transmit 407 a RRC resume message to the second device 120, and the second device 120 may transmit 408 a RRC resume complete message to the third device 130. Then the third device 130 may transmit 409 a RRC reconfiguration message comprising a relay related configuration to the second device 120, and the second device 120 may transmit 410 a RRC reconfiguration complete message to the third device 130. In this way, the second device 120 may be configured as a relay for a communication between the first device 110 and the third device 130.

With the process of FIG. 4, latency in sidelink relay may be reduced.

### Embodiment 4

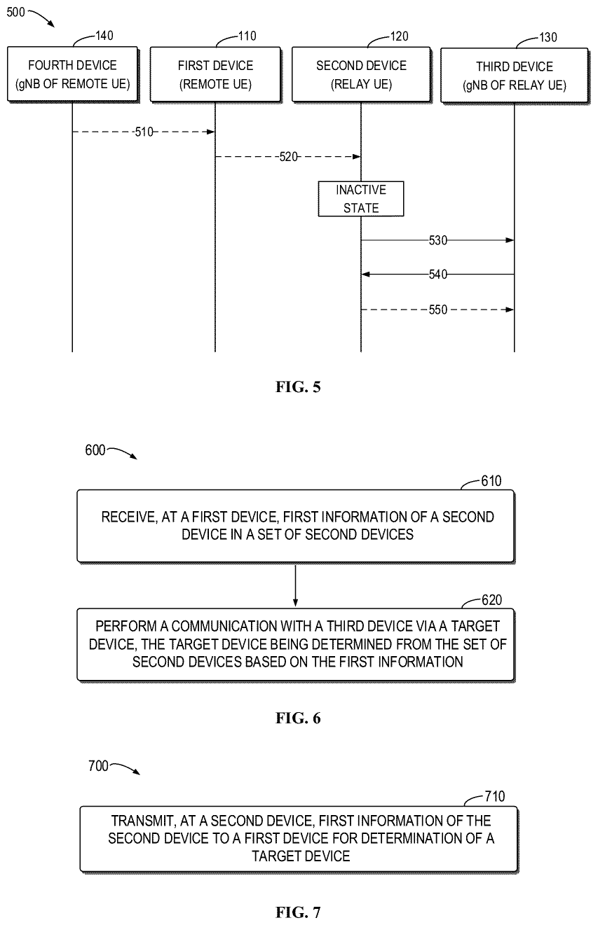

In this embodiment, if a serving device of a target device receives, from the target device, a request for resuming a connection with the serving device, the serving device of the target device transmits a message for resuming the connection comprising a configuration for relay (i.e., relay related configuration). This will be described in details with reference to FIG. 5.

FIG. 5 illustrates a schematic diagram illustrating a process 500 for communication for sidelink relay according to embodiments of the present disclosure. For the purpose of discussion, the process 500 will be described with reference to FIG. 1. The process 500 may involve the first device 110, the second device 120, the third device 130 and the fourth device 140 as illustrated in FIG. 1. The steps and the order of the steps in FIG. 5 are merely for illustration, and not for limitation. For example, the order of the steps may be changed. Some of the steps may be omitted or any other suitable additional steps may be added. Assuming that the first device 110 is to perform a communication via a target device in an inactive state. For convenience, assuming that the first device 110 is remote UE, the second device 120 is the target device, the third device 130 is gNB of the target device, and the fourth device 140 is gNB of the remote UE.

As shown in FIG. 5, the fourth device 140 may transmit 510 a RRC reconfiguration message comprising a relay related configuration to the first device 110. In this case, the first device 110 may transmit 520 a RRC reconfiguration complete message (i.e. via PC5 signaling) to the second device 120.

Upon reception of the RRC reconfiguration complete message, the second device 120 transmits 530, to the third device 130, a request for resuming a connection between the second device 120 and the third device 130. As a response to the request, the third device 130 transmits 540, to the second device 120, a message for resuming the connection. The message for resuming the connection comprises a configuration for relay. In some embodiments, the configuration for relay may comprise at least one of the following: a Uu RLC configuration for relay, a PC5 RLC configuration for relay, a bearer mapping configuration, or a local ID/AL ID and L2 ID of the first device 110. For example, the bearer mapping configuration may comprise at least one of the following, a mapping from a Uu E2E bearer ID in a Uu adaptation layer header to egress PC5 RLC channel ID/LCID: or a mapping from Uu E2E bearer ID used in PC5 adaptation layer header to egress Uu RLC channel ID/LCID.

Then the second device 120 may transmit 550 a RRC resume complete message to the third device 130. In this case, the third device 130 does not need to transmit the configuration for relay in a separate message.

With the process of FIG. 5, signaling overhead in sidelink relay may be saved and latency in sidelink relay may be reduced.

### Example Implementation of Methods

Accordingly; embodiments of the present disclosure provide methods of communication implemented at a remote UE, a device and their serving devices. These methods will be described below with reference to FIGS. 6 to 10.

FIG. 6 illustrates an example method 600 of communication implemented at a first device as remote UE in accordance with some embodiments of the present disclosure. For example, the method 600 may be performed at the first device 110 as shown in FIG. 1. For the purpose of discussion, in the following, the method 600 will be described with reference FIG. 1. It is to be understood that the method 600 may include additional blocks not shown and/or may omit some blocks as shown, and the scope of the present disclosure is not limited in this regard.

At block 610, the first device 110 receives first information of a second device (for example, the second device 120) in a set of second devices. For example, the first device 110 may receive respective first information from each device in the set of second devices. The first information comprises at least one of: a RRC state, serving node ID information, or a sidelink connection with the first device 110.

In some embodiments, the first device 110 may receive, from the second device 120, an indication indicating at least one of the RRC state or the serving node ID information, and obtain the first information from the indication. In some embodiments, the first device 110 may receive the indication in a discovery message from the second device 120. In some embodiments, the first device 110 may receive the indication in a message dedicated (e.g., PC5-S signaling or PC5 RRC signaling) for the first device 110.

In some embodiments, the first device 110 may transmit the first information to the fourth device 140 for determination of a target device by the fourth device 140. The first device 110 may perform communication via the target device.

In some embodiments, the first device 110 may determine a set of candidates from the set of second devices such that at least one of: the RRC state of a candidate in the set of candidates is a connected state; the serving node ID information of a candidate in the set of candidates indicates the fourth device 140: or a candidate in the set of candidates is in the sidelink connection with the first device 110. In these embodiments, the first device 110 may transmit second information indicating the set of candidates to the fourth device 140 for determination of the target device. In some alternative embodiments, the first device 110 may transmit both the first and second information to the fourth device 140 for determination of the target device.

In some embodiments, the first device 110 may receive, from the fourth device 140, a configuration indicating at least one of the following: the RRC state of a candidate in the set of candidates is a connected state; the serving node ID information of a candidate in the set of candidates indicates the fourth device 140; or a candidate in the set of candidates is in the sidelink connection with the first device 110. Based on the configuration, the first device 110 may determine the set of candidates.

In some embodiments, if the first device 110 receives a discovery message from the second device 120, the first device 110 may determine the RRC state of the second device 120 as a connected state. In some embodiments, the first and second devices 110 and 120 may be terminal devices, and the third and fourth devices 130 and 140 may be network devices.

At block 620, the first device 110 performs communication with the third device 130 via the target device.

With the method of FIG. 6, signaling overhead in sidelink relay may be saved and latency in sidelink relay may be reduced.

FIG. 7 illustrates an example method 700 of communication implemented at a second device as relay UE in accordance with some embodiments of the present disclosure. For example, the method 700 may be performed at the second device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the second device 120 transmits, to the first device 110, information of the second device 120 for determination of a target device. The first device 110 performs communication via the target device. The information comprises at least one of the following: a RRC state, serving node ID information, or a sidelink connection with the first device 110.

In some embodiments, the second device 120 may receive from the third device 130 an indication indicating the transmission of the information to the first device 110, and in response to the reception of the indication, the second device 120 may transmit the information to the first device 110.

In some embodiments, if the second device 120 is in a connected state, the second device 120 may transmit a discovery message. If the second device 120 is not in the connected state, the second device 120 may not transmit the discovery message.

In some embodiments, the second device 120 may receive, from the third device 130, an indication indicating that the discovery message is transmitted if the second device 120 is in the connected state. Based on the indication, the second device 120 may transmit the discovery message if the second device 120 is in the connected state and may not transmit the discovery message if the second device 120 is not in the connected state.

With the method of FIG. 7, signaling overhead in sidelink relay may be reduced.

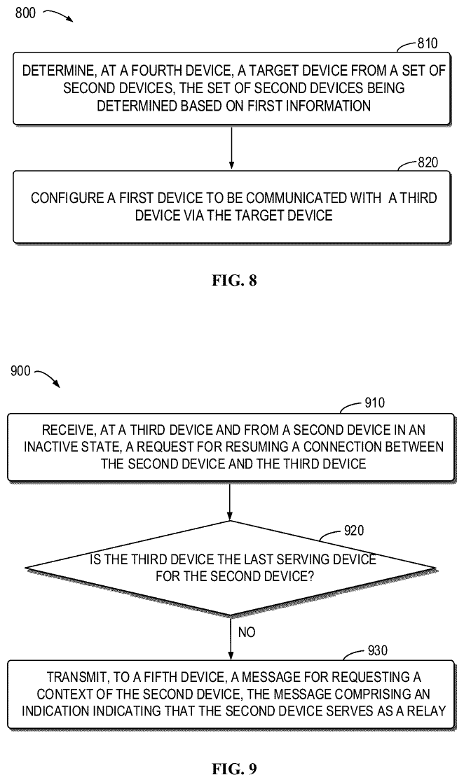

FIG. 8 illustrates an example method 800 of communication implemented at a fourth device as a serving device of remote UE in accordance with some embodiments of the present disclosure. For example, the method 800 may be performed at the fourth device 140 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the fourth device 140 determines a target device (for example, the second device 120) from a set of second devices based on first information of a second device in the set of second devices, the first information comprising at least one of: a RRC state, serving node ID information, or a sidelink connection with the first device 110.

In some embodiments, the fourth device 140 may transmit, to a second device in a subset of the set of second devices (in other words, a second device served by the fourth device 140), an indication indicating transmission of the first information to the first device 110.

In some embodiments, the fourth device 140 may receive, from the first device 110, at least one of the following: second information indicating a set of candidates, or the first information, and determine the set of second devices based on at least one of the second information or the first information. In some embodiments where the second information is received, the fourth device 140 may determine the set of candidates as the set of second devices. In some embodiments where the first information is received, the fourth device 140 may determine the set of second devices from the first information.

In some embodiments, the fourth device 140 may transmit a configuration to the first device 110, the configuration indicating that at least one of: the RRC state of a candidate in the set of candidates is a connected state; the serving node ID information of a candidate in the set of candidates indicates the fourth device 140; or a candidate in the set of candidates is in the sidelink connection with the first device 110.

In some embodiments, the fourth device 140 may receive, from the second device 120 or the first device 110, a first identity of the sidelink connection with the first device 110: map the first identity into a second identity of the second device 120 in a RAN; and obtain the first information based on the second identity.

In some embodiments, the fourth device 140 may receive, from the first device 110, a measurement report indicating the set of second devices. The fourth device 140 may determine the set of second devices from the measurement report.

In some embodiments, the fourth device 140 may transmit, to the third device 130, a request for obtaining the first information of the second device 120, and receive, from the third device 130, a response to the request, the response comprising the first information.

Then the fourth device 140 may determine the target device from the set of second devices based on the first information.

In some embodiments, the fourth device 140 may receive the first information from the third device 130, and determine the target device from the set of second devices based on the first information.

In some embodiments, the fourth device 140 may determine the target device such that at least one of: the RRC state of the target device is a connected state; the serving node ID information of the target device indicates the fourth device 140; or the target device is in the sidelink connection with the first device 110. In some embodiments, the fourth device 140 may store the first information in a variable, or UE context or a NCRT.

At block 820, the fourth device 140 configures the first device 110 to be communicated with the third device 130 via the target device (i.e., the second device 120).

With the method of FIG. 8, signaling overhead in Uu interface may be saved and UE complexity may be reduced.

FIG. 9 illustrates an example method 900 of communication implemented at a third device as a serving device of relay UE in accordance with some embodiments of the present disclosure. For example, the method 900 may be performed at the third device 130 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard. Assuming that the second device 120 is a target device and is in an inactive state.

At block 910, the third device 130 receives, from the second device 120, a request for resuming a connection between the second device 120 and the third device 130.

At block 920, the third device 130 determines whether the third device 130 is not the last serving device of the second device 120. If the third device 130 is not the last serving device of the second device 120, the process 900 proceeds to block 930.

At block 930, the third device 130 transmits, to the fifth device 150, a message for requesting a context of the second device 120, the message comprising an indication that the second device 120 serves as a relay.

With the method of FIG. 9, the fifth device 150 is caused to surely transmit the context of the second device 120 to the third device 130. Thus, latency in sidelink relay may be reduced.

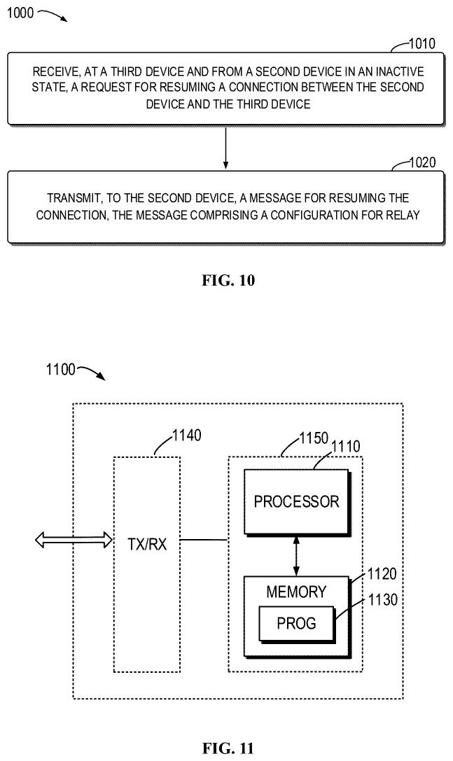

FIG. 10 illustrates another example method 1000 of communication implemented at a third device as a serving device of relay UE in accordance with some embodiments of the present disclosure. For example, the method 1000 may be performed at the third device 130 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard. Assuming that the second device 120 is a target device and is in an inactive state.

At block 1010, the third device 130 receives, from the second device 120, a request for resuming a connection between the second device 120 and the third device 130.

At block 1020, the third device 130 transmits, to the second device 120, a message for resuming the connection, the message comprising a configuration for relay.

With the method of FIG. 10, signaling overhead in sidelink relay may be saved and latency in sidelink relay may be reduced.

### Example Implementation of Device and Apparatus

FIG. 11 is a simplified block diagram of a device 1100 that is suitable for implementing embodiments of the present disclosure. The device 1100 can be considered as a further example implementation of the first device 110, the second device 120, the third device 130, the fourth device 140 or the fifth device 150 as shown in FIG. 1. Accordingly, the device 1100 can be implemented at or as at least a part of the first device 110, the second device 120, the third device 130, the fourth device 140 or the fifth device 150.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a first device comprises circuitry configured to: receive first information of a second device in a set of second devices, the first information comprising at least one of: a radio resource control state, serving node identity information, or a sidelink connection with the first device; and perform a communication with a third device via a target device, the target device being determined from the set of second devices based on the first information.

In some embodiments, the circuitry may be configured to receive the first information by: receiving, from the second device, an indication indicating at least one of the radio resource control state or the serving node identity information; and obtaining the first information from the indication.

In some embodiments, the circuitry may be configured to receive the indication by at least one of: receiving the indication in a discovery message from the second device: or receiving the indication in a message specific to the first device.

In some embodiments, the circuitry may be further configured to transmit the first information to a fourth device for determination of the target device. In some embodiments, the circuitry may be further configured to: determine a set of candidates from the set of second devices such that at least one of: the radio resource control state of a candidate in the set of candidates is a connected state; the serving node identity information of a candidate in the set of candidates indicates a fourth device; or a candidate in the set of candidates is in the sidelink connection with the first device; and transmit second information indicating the set of candidates to the fourth device for determination of the target device.

In some embodiments, the circuitry may be configured to determine the set of candidates by: receiving, from the fourth device, a configuration indicating at least one of the following: the radio resource control state of a candidate in the set of candidates is a connected state; the serving node identity information of a candidate in the set of candidates indicates the fourth device; or a candidate in the set of candidates is in the sidelink connection with the first device; and determining the set of candidates based on the configuration.

In some embodiments, the circuitry may be configured to receive the first information by: in response to receiving a discovery message from the second device, determining the radio resource control state of the second device as a connected state.

In some embodiments, the first and second devices are terminal devices, and the third and fourth devices are network devices.

In some embodiments, a second device comprises a circuitry configured to transmit, to a first device, information of the second device for determination of a target device, the first device communicating with a third device via the target device, the information comprising at least one of: a radio resource control state, serving node identity information, or a sidelink connection with the first device.

In some embodiments, the circuitry may be further configured to receive, from the third device, an indication indicating the transmission of the information to the first device.

In some embodiments, the circuitry may be further configured to: in accordance with a determination that the second device is in a connected state, transmit, at the second device, a discovery message; and in accordance with a determination that the second device is not in the connected state, transmit no discovery message.

In some embodiments, the circuitry may be further configured to receive, from the third device, an indication indicating that the discovery message is transmitted if the second device is in the connected state.

In some embodiments, a fourth device comprises a circuitry configured to: determine a target device from a set of second devices based on first information of a second device in the set of second devices, the first information comprising at least one of: a radio resource control state, serving node identity information, or a sidelink connection with a first device; and configure the first device to be communicated with a third device via the target device.

In some embodiments, the circuitry may be further configured to transmit, to a second device in a subset of the set of second devices, an indication indicating transmission of the first information to the first device, the second device in the subset being served by the fourth device.

In some embodiments, the circuitry may be configured to determine the set of second devices by: receiving, from the first device, at least one of the following: second information indicating a set of candidates, or the first information; and determining the set of second devices based on at least one of the second information or the first information. In some embodiments, the circuitry may be configured to determine the set of second devices by determining the set of candidates as the set of second devices.

In some embodiments, the circuitry may be further configured to determine the set of second devices by receiving, from the first device, a measurement report indicating the set of second devices.

In some embodiments, the circuitry may be configured to determine the target device by: transmitting, to the third device, a request for obtaining the first information of the second device: receiving, from the third device, a response to the request, the response comprising the first information; and determining the target device from the set of second devices based on the first information.

In some embodiments, the circuitry may be configured to determine the target device by: receiving the first information from the third device; and determining the target device from the set of second devices based on the first information.

In some embodiments, the circuitry may be configured to determine the target device such that at least one of: the radio resource control state of the target device is a connected state; the serving node identity information of the target device indicates the fourth device; or the target device is in the sidelink connection with the first device.

In some embodiments, the circuitry may be further configured to store the first information in a variable or a neighbor cell relation table.

In some embodiments, the circuitry may be further configured to transmit a configuration to the first device, the configuration indicating that at least one of: the radio resource control state of a candidate in the set of candidates is a connected state; the serving node identity information of a candidate in the set of candidates indicates the fourth device; or a candidate in the set of candidates is in the sidelink connection with the first device.

In some embodiments, the circuitry may be further configured to: receive, from the second device or the first device, a first identity of the sidelink connection with the first device: map the first identity into a second identity of the second device in a radio access network; and obtain the first information based on the second identity:

In some embodiments, a third device comprises a circuitry configured to: receive, from a second device in an inactive state, a request for resuming a connection between the second device and the third device, wherein a communication between a first device and the third device is to be performed via the second device; and in accordance with a determination that the third device is not the last serving device of the second device, transmit, to a fifth device as the last serving device of the second device, a message for requesting a context of the second device, the message comprising an indication that the second device serves as a relay.

In some embodiments, a third device comprises a circuitry configured to: receive, from a second device in an inactive state, a request for resuming a connection between the second device and the third device, wherein a communication between a first device and the third device is to be performed via the second device; and transmit, to the second device, a message for resuming the connection, the message comprising a configuration for relay.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a first device, first information of a second device in a set of second devices, the first information comprising at least one of:
a radio resource control state,
serving node identity information, or
a sidelink connection with the first device; and
performing a communication with a third device via a target device, the target device being determined from the set of second devices based on the first information.

2. The method of claim 1, wherein receiving the first information comprises:
receiving, from the second device, an indication indicating at least one of the radio resource control state or the serving node identity information; and
obtaining the first information from the indication.

3. The method of claim 2, wherein receiving the indication comprises at least one of:
receiving the indication in a discovery message from the second device: or
receiving the indication in a message specific to the first device.

4. The method of claim 1, further comprising:
transmitting the first information to a fourth device for determination of the target device.

5. The method of claim 1 or 4, further comprising:
determining a set of candidates from the set of second devices such that at least one of:
the radio resource control state of a candidate in the set of candidates is a connected state:
the serving node identity information of a candidate in the set of candidates indicates a fourth device; or
a candidate in the set of candidates is in the sidelink connection with the first device; and
transmitting second information indicating the set of candidates to the fourth device for determination of the target device.

6. The method of claim 5, wherein determining the set of candidates comprises:
receiving, from the fourth device, a configuration indicating at least one of the following:
the radio resource control state of a candidate in the set of candidates is a connected state:
the serving node identity information of a candidate in the set of candidates indicates the fourth device: or
a candidate in the set of candidates is in the sidelink connection with the first device; and
determining the set of candidates based on the configuration.

7. The method of claim 1, wherein receiving the first information comprises:
in response to receiving a discovery message from the second device, determining the radio resource control state of the second device as a connected state.

8. The method of claim 4, wherein the first and second devices are terminal devices, and the third and fourth devices are network devices.

9. A method of communication, comprising:
transmitting, at a second device and to a first device, information of the second device for determination of a target device, the first device communicating with a third device via the target device, the information comprising at least one of:
a radio resource control state,
serving node identity information, or
a sidelink connection with the first device.

10. The method of claim 9, further comprising:
receiving, from the third device, an indication indicating the transmission of the information to the first device.

11. The method of claim 9, further comprising:
in accordance with a determination that the second device is in a connected state, transmitting, at the second device, a discovery message; and
in accordance with a determination that the second device is not in the connected state, transmitting no discovery message.

12. The method of claim 11, further comprising:
receiving, from the third device, an indication indicating that the discovery message is transmitted if the second device is in the connected state.

13. A method of communication, comprising:
determining, at a fourth device, a target device from a set of second devices based on first information of a second device in the set of second devices, the first information comprising at least one of:
a radio resource control state,
serving node identity information, or
a sidelink connection with a first device; and
configuring the first device to be communicated with a third device via the target device.

14. The method of claim 13, further comprising:
transmitting, to a second device in a subset of the set of second devices, an indication indicating transmission of the first information to the first device, the second device in the subset being served by the fourth device.

15. The method of claim 13, further comprising determining the set of second devices by:
receiving, from the first device, at least one of the following: second information indicating a set of candidates, or the first information; and
determining the set of second devices based on at least one of the second information or the first information.

16. The method of claim 15, wherein determining the set of second devices comprises:
determining the set of candidates as the set of second devices.

17. The method of claim 13, further comprising determining the set of second devices by:
receiving, from the first device, a measurement report indicating the set of second devices.

18. The method of claim 13 or 17, wherein determining the target device comprises:
transmitting, to the third device, a request for obtaining the first information of the second device:
receiving, from the third device, a response to the request, the response comprising the first information; and
determining the target device from the set of second devices based on the first information.

19. The method of claim 13 or 17, wherein determining the target device comprises:
receiving the first information from the third device; and
determining the target device from the set of second devices based on the first information.

20. The method of claim 13, wherein determining the target device comprises determining the target device such that at least one of:
the radio resource control state of the target device is a connected state;
the serving node identity information of the target device indicates the fourth device; or
the target device is in the sidelink connection with the first device.

21. The method of claim 13, further comprising:
storing the first information in a variable or a neighbor cell relation table.

22. The method of claim 15, further comprising transmitting a configuration to the first device, the configuration indicating that at least one of:
the radio resource control state of a candidate in the set of candidates is a connected state;
the serving node identity information of a candidate in the set of candidates indicates the fourth device; or
a candidate in the set of candidates is in the sidelink connection with the first device.

23. The method of claim 13, further comprising:
receiving, from the second device or the first device, a first identity of the sidelink connection with the first device:
mapping the first identity into a second identity of the second device in a radio access network; and
obtaining the first information based on the second identity.

24. A method of communication, comprising:
receiving, at a third device and from a second device in an inactive state, a request for resuming a connection between the second device and the third device, wherein a communication between a first device and the third device is to be performed via the second device; and
in accordance with a determination that the third device is not the last serving device of the second device, transmitting, to a fifth device as the last serving device of the second device, a message for requesting a context of the second device, the message comprising an indication that the second device serves as a relay.

25. A method of communication, comprising:
receiving, at a third device and from a second device in an inactive state, a request for resuming a connection between the second device and the third device, wherein a communication between a first device and the third device is to be performed via the second device; and
transmitting, to the second device, a message for resuming the connection, the message comprising a configuration for relay.

26. A device of communication, comprising:
a processor configured to perform the method according to any of claims 1 to 8 or any of claims 9-12.

27. A device of communication, comprising:
a processor configured to perform the method according to any of claims 13 to 23, claim 24, or claim 25.
